(19) United States
(12) Patent Application Publication
(10) Pub. No.: US 2023/0264621 A1
(43) Pub. Date: Aug. 24, 2023

(54) FOLDABLE ROOFTOP SHELTER

(71) Applicants: Alan Qiu Wang, Saline, MI (US); Philip Hua wang, Saline, MI (US)

(72) Inventors: Alan Qiu Wang, Saline, MI (US); Philip Hua wang, Saline, MI (US)

(21) Appl. No.: 18/079,380

(22) Filed: Dec. 12, 2022

Related U.S. Application Data
(60) Provisional application No. 63/313,038, filed on Feb. 23, 2022.

(51) Int. Cl. B60P 3/34; E04H 15/00; E04H 15/06

(52) U.S. Cl. CPC B60P 3/34; E04H 15/008; E04H 15/06

(57) ABSTRACT

A rooftop shelter that can be mounted to a roof of a vehicle and can be quickly and readily assembled and disassembled. The rooftop shelter includes a body and a hinged cover that resembles a suitcase. A roof panel is pivotally coupled to the hinged cover. A left wall panel, a right wall panel, and a front wall panel can be coupled to three respective sides of the body. The body and the hinged cover in the folded state can encase the above four panels. The rooftop shelter can be set up by unfolding the hinged cover and the four panels, wherein the body, hinged cover, roof panel, left panel, right panel, and front panel together form an enclosure. This same structure can use for quick movable ground shelters.

### CROSS-REFERENCE TO RELATED APPLICATIONS

This application claims priority from a U.S. Provisional Patent Appl. No. 63/313,038 filed on Feb. 23, 2022, which is incorporated herein by reference in its entirety.

### FIELD OF INVENTION

The present invention relates to a hardboard rooftop shelter, and more particularly, the present invention relates to a foldable rooftop hardboard shelter for a vehicle and a portable ground shelter.

### BACKGROUND

Portable tents are quite popular for outdoor excursions, explorations, camping, and the like activities. Roof-mounted tents are also being widely used. These tents can be mounted to a roof of a vehicle, such as an automobile. The roof-mounted tents offer certain advantages, such as safety and comfort. A variety of roof-mounted tents are available that differ in various aspects. The known roof-mounted tents, however, suffer from several drawbacks and limitations, such as soundproofing, insulation and safety etc.

A need is therefore appreciated for a novel roof-mounted hardboard shelter that is devoid of the aforesaid drawbacks with conventional roof-mounted tents and has an added advantage of a portable ground shelter.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a hard panel shelter that can be readily folded and unfolded.

It is an object of the present invention that the hard panel shelter can be easy to mount on a vehicle top.

It is another object of the present invention that the rooftop shelter is rigid that can resist winds and harsh weather.

It is still another object of the present invention that the rooftop shelter provides thermal and sound insulation.

It is yet another object of the present invention that the rooftop shelter provides better comfort and safety.

In one aspect, disclosed is a rooftop shelter has six main panels, which includes a base panel (hereafter refer to body), a back wall panel, a roof panel, a left wall panel, a right wall panel, and a front wall panel. The body can mount to a roof rack, the bottom side of back wall panel is hinged to the body rear side, the roof panel rear side is hinged to the top side of the back wall panel, the bottom side of the left wall panel is hinged to the left side of the body, the bottom side of the right wall panel is hinged to the right side of the body, the bottom side of the front wall panel is hinged to the front side of the body, the front wall panel has a hinged door for person in and out. The roof panel is latched to the front wall panel, the shelter become to a rigid box structure.

In one implementation, the body is configured to be mounted to a roof rack of a vehicle. The rooftop shelter further comprises one or more windows in the left wall panel and/or right wall panel. The rooftop shelter further comprises a door in the front wall panel. The door has a window. The one or more windows are shielded by one or more mesh screens. The rooftop shelter further comprises one or more locks disposed on the front side of the body and the front side of the hinged cover for securing the hinged cover to the body. The front side of the hinged cover further comprises a handle. Each of the front wall panel, the right wall panel, the left wall panel, and the roof panel has metal or hard material moldings on three sides, the three sides are other than a side pivotally coupled, wherein the moldings permit interlocking of the front wall panel with the left wall panel and the right wall panel and interlocking of the roof panel with the left wall panel, the right wall panel, and the front wall panel. The rooftop shelter further comprises one or more hydraulic gas springs that extend between the hinged cover and the body for easy operate.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows the rooftop shelter in an unfolded state, according to an exemplary embodiment of the present invention.

FIG. 2 shows the rooftop shelter in a folded state, according to an exemplary embodiment of the present invention.

FIG. 3 shows the rooftop shelter mounted to a roof of a vehicle, according to an exemplary embodiment of the present invention.

FIG. 4 shows a sectional view of the panel of the rooftop shelter, according to an exemplary embodiment of the present invention.

FIG. 5 shows the rooftop shelter for use on the ground, according to an exemplary embodiment of the present invention.

FIG. 6 shows a first step in assembling the rooftop shelter, according to an exemplary embodiment of the present invention.

FIG. 7 shows a second step in assembling the rooftop shelter, according to an exemplary embodiment of the present invention.

FIG. 8 shows a third step in assembling the rooftop shelter, according to an exemplary embodiment of the present invention.

FIG. 9 shows a fourth step in assembling the rooftop shelter, according to an exemplary embodiment of the present invention.

FIG. 10 shows a fifth step in assembling the rooftop shelter, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form to facilitate describing the subject innovation. Moreover, the drawings may not be to scale.

Disclosed is a rooftop shelter that can be mounted to the roof of the vehicle, such as a truck, SUV, and the like. The disclosed rooftop shelter can be readily set up and folded with ease without much labor which is particularly advantageous over the known rooftop shelters. A person can set up and fold the disclosed rooftop shelter on a roof of a vehicle while standing on the ground or at a small height, thus reducing the risk of injury significantly. Thus, the disclosed rooftop shelter can provide both comfort and safety.

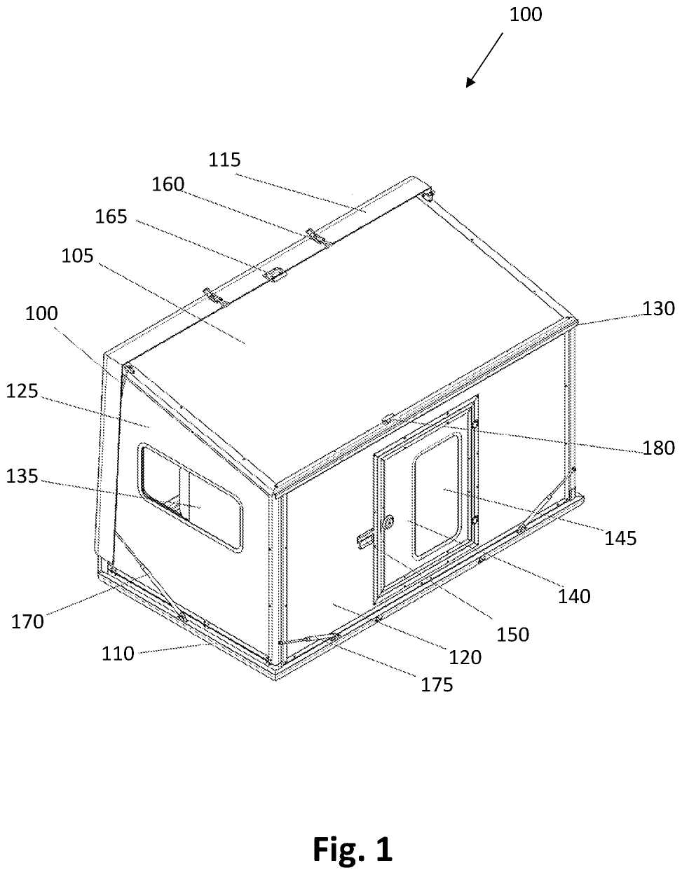

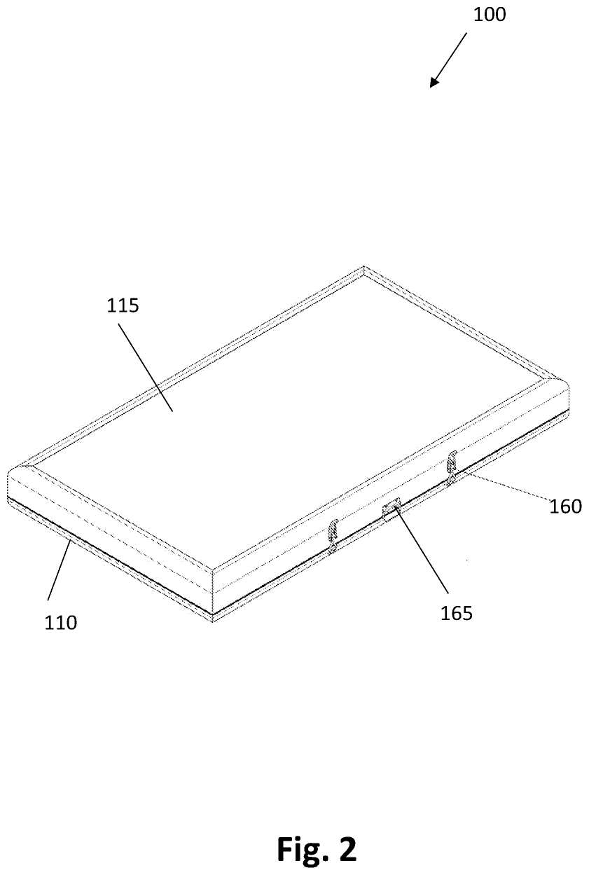

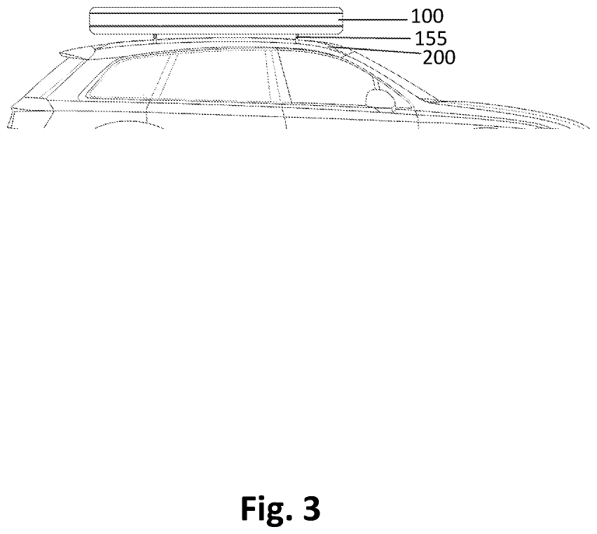

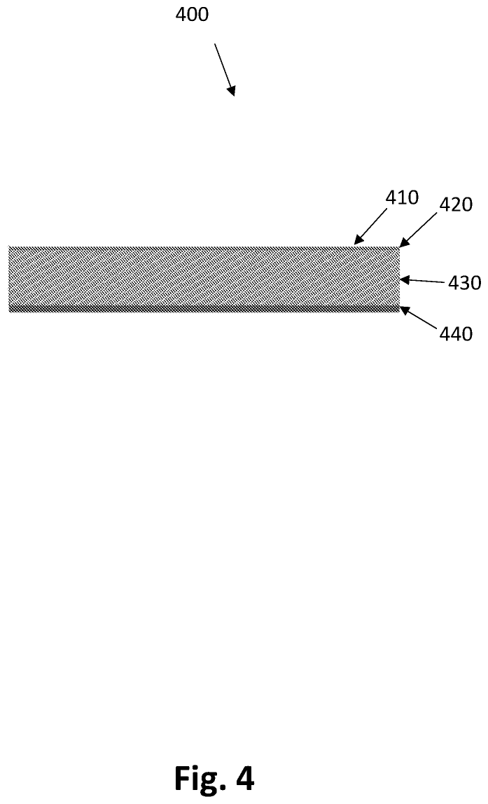

Referring to FIGS. 1-3 which show an exemplary embodiment of a rooftop shelter that can be mounted to a roof rack of the vehicle. FIG. 1 shows a rooftop shelter 100 in a set up/unfolded/assembled state. FIG. 2 shows the rooftop shelter 100 in the folded state. FIG. 3 shows the rooftop shelter 100 mounted to a roof of a vehicle 200. FIG. 4 shows a section of a panel of the disclosed rooftop shelter. The panel is rigid, durable, and lightweight in construction. The rooftop shelter can be implemented in a form of an enclosure resembling a big suitcase with a body 110 and a hinged cover 115. The body can form the bottom of the rooftop shelter while the hinged cover can form a back wall panel of the disclosed rooftop shelter. The body has a flat central section and a skirt that extends upward from the periphery of the central section to define an inner volume of the body. Similarly, the cover can have a flat central section and a skirt that extends downwards along a periphery of the central section defining an inner volume of hinged cover. The hinged cover can at one side be coupled to the body through one or more hinge joints that allow the cover to be pivotally open and close. The other side of the hinged cover can be provided with suitable latches 160 and locks to secure the hinged cover to the body for preventing the opening of the hinged cover. A handle 165 can also be provided on this side of the hinged cover that can be grabbed in a hand to lift or pull the hinged cover. In one implementation, the hinged cover can tightly mount over the body to prevent the ingress of dust and like materials into the body when the rooftop shelter is in a closed state. Also, the hinged cover can be sealable fixed on the body by latch 160 prevent the ingress of water and air.

The disclosed rooftop shelter 100 can further include a roof panel 105, a front wall panel 120, a left wall panel 125, and a right wall panel 130. The roof panel can form the roof of the disclosed rooftop shelter, while the left wall panel, the right wall panel, and the front wall panel can form the side walls of the rooftop shelter. The body, the back wall panel defined by the hinged cover, and the four panels can be assembled to form an enclosure as shown in FIG. 1. The left wall panel and the right wall panel can be provided with windows 135. The windows can be useful for ventilation and outside view. Each window can be provided with a cover to open and close the window. FIG. 1 shows the window having a slidable glass or synthetic glass.

The window can also be provided with a mosquito screen such that to prevent the ingress of mosquitoes while allowing proper ventilation. It is understood, however, that the windows may be optional, or one or more windows can be provided. The windows can be provided at any suitable place in the rooftop shelter, such as in the roof panel or the front wall panel. FIG. 1 shows the windows in side panels are for illustration only, but the location of windows can be varied without departing from the scope of the present invention. Also, the shape and size of the windows can be varied without departing from the scope of the present invention.

To gain access to the disclosed rooftop shelter, a door 140 can also be provided. Preferably, the door can be provided in the front wall panel which may be accessible from the side of the vehicle. Through the door, an adult person can easily get in and get out. The door can be coupled to the front wall panel through two or more hinge joints. A door lock and handle can also be provided for safety. Preferably, the door being of a taller profile can open horizontally i.e., side wards. However, the door can also be mounted to open vertically without departing from the scope of the present invention. Suitable supports can also be provided to hold the door in the open state when mounted vertically. The door itself can also be provided with a window 145. The window can be covered with glass so that enough light can get into the disclosed rooftop shelter. The door can also be provided with a door lock 150 to secure the door to the front wall panel.

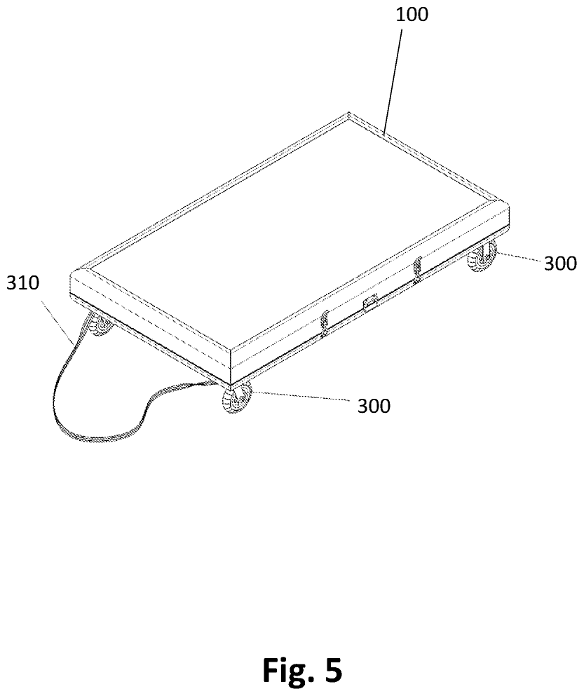

Referring to FIG. 3 shows the rooftop shelter 100 mounted to a roof of vehicle 200. The body of the rooftop shelter 100 can have clamps 155 to fasten the rooftop shelter 100 to the roof rail, frame, and like structures on the roof of the vehicle. The four removable wheels 300 can be mounted at four bottom corners for the rooftop shelter 100. FIG. 5 shows the rooftop shelter 100 in a folded state with four wheels 300 on which the rooftop shelter 100 can roll. A strap 310 is also shown that can be used to pull the rooftop shelter 100. The implementation shown in FIG. 5 can be useful when the rooftop shelter 100 is used on the ground. It can also be used as an outdoor dining table, a picnic platform, a viewing and rest platform, etc., without fear of insect ant harassment and mild moisture on the ground. The shelter can pull to a place and hold up to a ground shelter.

Referring to FIG. 4 shows a section 400 of a panel from which the rooftop shelter 100 can be made. The panel can have a first layer 410 which is the outermost layer of weather-resistant coating that can protect the panels from environmental corrosive agents, rust, and the like. A second layer 420 adjacent to the first layer 410 can be of a Fiber-reinforced composite layer or plastic that can provide strength to the panel. A third layer 430 can be of a lightweight hard foaming material for insulation. A fourth layer 440 which is an innermost layer can be provided for strength and providing a smooth and odorless feel appearance, and sense. The panels are sandwich structure that allows making the disclosed rooftop shelter that is rigid, light in weight, durable, and can easily accommodate two adults and protect them from chilly weather and winds. Edges of the panels are made by metallic flanges, such as aluminum magnesium alloy, which increases the strength of the panels.

The hinged cover (back wall panel) bottom side is hinged to the rear side of the body, the roof panel rear side is hinged to the top of the hinged cover. When folding, the roof panel rotates down till against the hinged cover and latched to the hinged cover at bottom, therefor the hinged cover and roof panel become to one piece, they can rotate together around the body rear side hinge axis. The left wall panel can be pivotally coupled to the left side of the body, such that the left wall panel can pivot between a horizontal state and a vertical state. Similarly, the right wall panel can be pivotally coupled to the right side of the body. The right wall panel can also pivot between a horizontal state and a vertical state, wherein the right and left wall panel can be lifted from the horizontal state to the vertical state. The front wall panel can be pivotally coupled to the front side of the body, wherein the front wall panel can be pivoted between the horizontal state and the vertical state. The front wall panel can lie flat parallel to the inner surface of the body. In one implementation, there may be enough space available between the body and the front wall panel such that bedding can be sandwiched between the front wall panel and the body at folded stage. The left wall panel and the right wall panel in the horizontal state can overlie on top of the front wall panel. Suitable hydraulics can be provided that eases the lifting of the hinged cover and the panels. FIG. 1 shows a hydraulic arm 170 for the hinged cover, a hydraulic arm 175 for the left wall panel, and another hydraulic arm for the right wall panel. Similarly, hydraulic arms can be provided for all the panels, however, such hydraulic arms can be optional. The hydraulic arm can be hydraulic gas spring based. Moreover, the hydraulics can be replaced by any other mechanism, such as electronic actuators can be provided in place of the hydraulic arms. A handle 180 can also be seen in FIG. 1 at the edge of the hinged cover, the handle 180 can be grabbed in a hand to pull the hinged cover with the roof panel upwards from a vertical state to a horizontal state.

The roof panel, the front wall panel, the left wall panel, and the right wall panel can be provided with suitable edge moldings on three sides so that the panels can interlock with each other at unfold stage. The interlocked panels can provide a sturdy setup that can hold up the disclosed rooftop shelter in windy weather. For example, the front wall panel and the left wall panel can interlock at the edge molding. The front wall panel and the right wall panel can interlock with the edge molding. The left wall panel and the right wall panel can sealed with the skirt of the hinged cover. The roof panel can interlock and latch with the left wall panel, the front wall panel, and the right wall panel to prevent the structure from collapsing. The molding may provide sealable interlocking of the panels such that water, air, dirt, insects, and the like cannot penetrate from spaces between the panels.

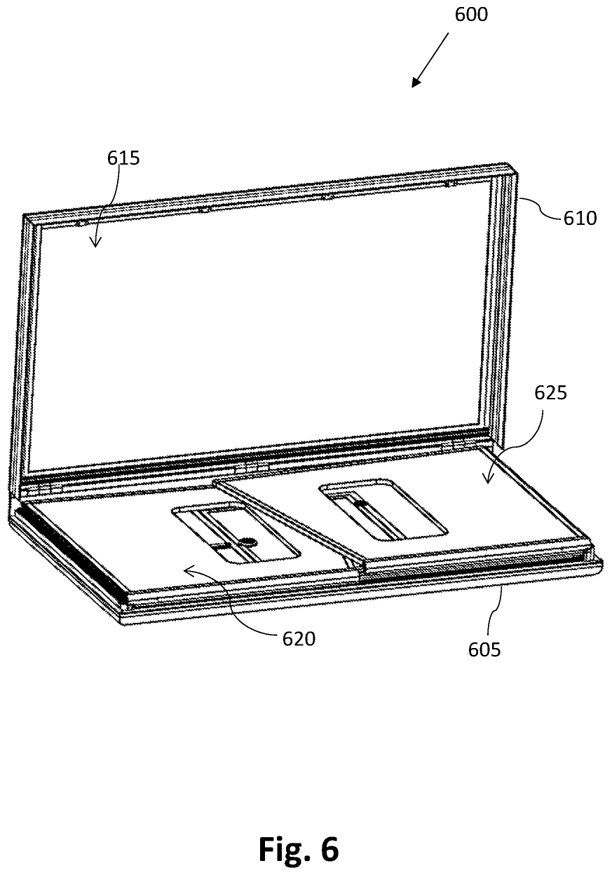

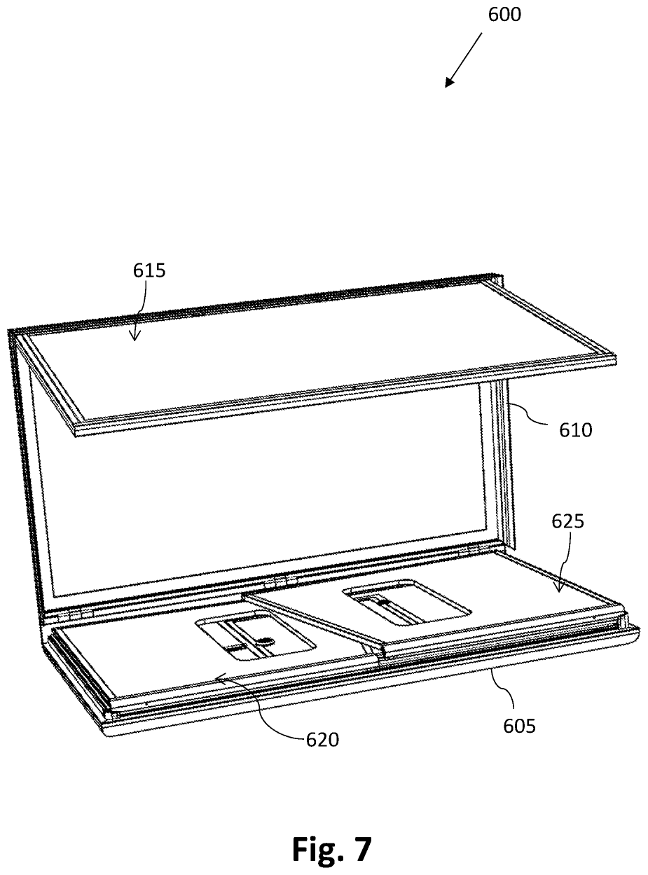

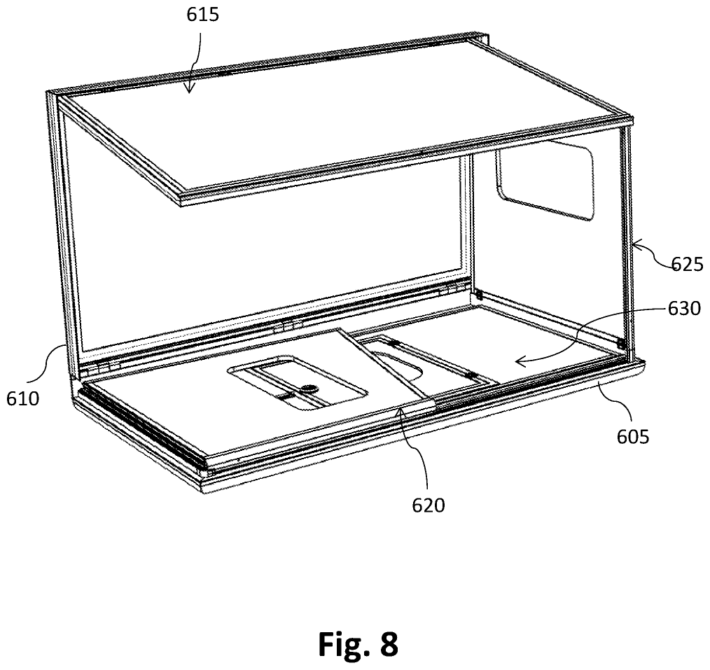

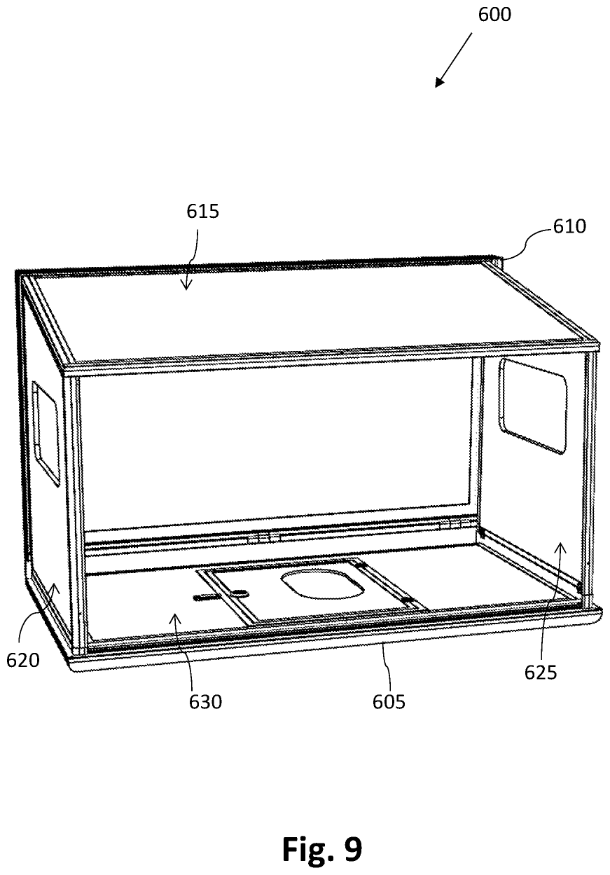

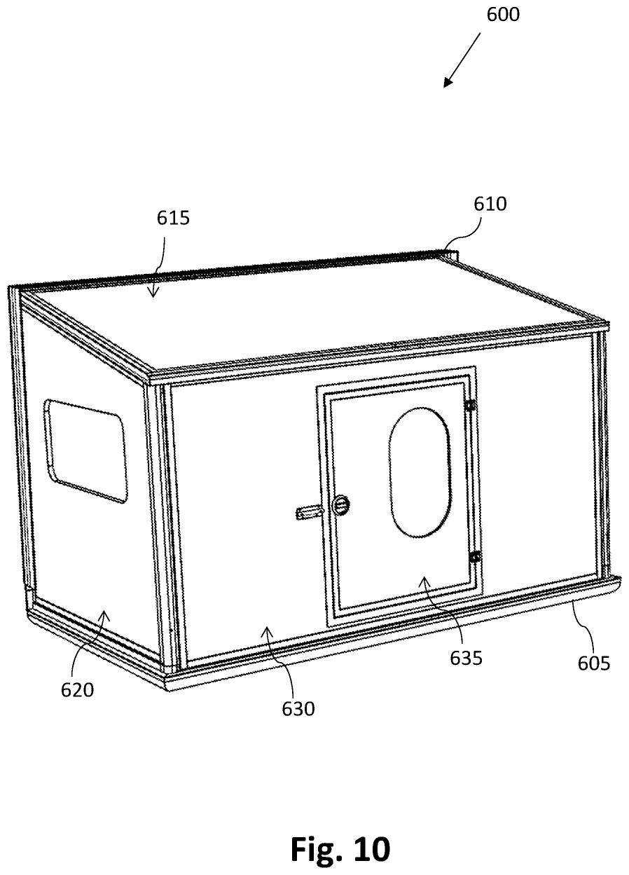

Referring to FIGS. 6-10 show steps to set up the disclosed rooftop shelter. FIGS. 2 and 3 show the rooftop shelter in a closed state. To set up the rooftop shelter, a user can unlock the hinged cover latches. Thereafter, the user can grasp the handle of the hinged cover and lift the same to a suitable height. Thereafter, the hinged cover can be pushed backward to substantially a vertical state assisted by the hydraulic gas spring. FIG. 6 shows the rooftop shelter device 600 which includes a body 605 and a hinged cover 610, wherein the hinged cover 610 is shown in the open state. Thereafter, the roof panel 615 can be pulled out by grabbing a handle on the bottom side of the roof panel and unlatch the roof panel from the hinged cover by same handle. FIG. 7 shows the roof panel 615 pivoted upwards to a horizontal state by hydraulic spring arms automatically. Now the roof panel stays at the horizontal position, lift either the left wall panel or the right wall panel upwards to the vertical state assisted by hydraulic spring arms and both stay at vertical position. Now lift the front wall panel from the horizontal state to the vertical state by grabbing the handle 150 on the front wall panel, shown in FIG. 1, the front wall panel is interlocked with the left and right wall panel front side by shaped edge frames. Pulling down the roof panel till contact three wall top edges firmly. The roof panel can interlock with all three wall panels and latched to the top of the front wall panel to prevent the rooftop shelter from collapsing.

The user can climb up in the rooftop shelter mounted on the vehicle using a ladder. The ladder can preferably be telescoping leather made from light and durable material that can be easily stored and carried. Telescoping aluminum-made ladders can be used which can be carried in the vehicle.

To fold the rooftop shelter, unlatch the roof panel forms the front wall panel, the roof panel will automatically tilt open to flat position by hydraulic spring arms. Thereafter, the front panel can be pushed into the body, followed by the left wall panel and right wall panel. Then the roof panel can be pushed towards the inner of the hinged cover and locked by handle latch. Finally, the hinged cover can be dropped over the body and locked become to one flat box.

The rooftop shelter can also be modified for ground installation. The rooftop shelter is easy to take off form the vehicle by unbolt the clamps form the roof rack. The rooftop shelter can be made portable by attached removable wheels at bottom of the body. FIG. 5 shows wheels 300 at bottom of the body, such as caster wheels. A suitable quick-release mechanism can be provided for mounting the wheels, wherein the wheel can be mounted and removed as per the requirement. A strap 310 can also be provided to pull the disclosed rooftop shelter.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A rooftop shelter comprising:
a body, the body has a left side, a front side, a right side, and a rear side;
a hinged cover that has a front side and a rear side, the rear side of the hinged cover is pivotally coupled to the rear side of the body, the hinger covers forms a back wall panel;
a left wall panel pivotally coupled to the left side of the body, the left wall panel configured to pivot between a horizontal state and a vertical state;
a right wall panel pivotally coupled to the right side of the body, the right wall panel configured to pivot between a horizontal state and a vertical state;
a front wall panel pivotally coupled to the front side of the body, the front wall panel configured to pivot between a horizontal state and a vertical state; and
a roof panel, the roof panel is pivotally coupled to the front side of the hinged cover,
wherein the body, the back wall panel, the left wall panel, the front wall panel, the right wall panel, and the roof panel together form a collapsible enclosure.

2. The rooftop shelter according to claim 1, wherein the body is configured to be mounted to a roof of a vehicle.

3. The rooftop shelter according to claim 1, wherein the rooftop shelter further comprises:
one or more windows in the left wall panel and/or right wall panel.

4. The rooftop shelter according to claim 1, wherein the rooftop shelter further comprises a door in the front wall panel.

5. The rooftop shelter according to claim 4, wherein the door has a window.

6. The rooftop shelter according to claim 3, wherein the one or more windows are shielded by one or more mesh screens.

7. The rooftop shelter according to claim 1, wherein the rooftop shelter further comprises:
one or more door locks disposed on the front side of the body and the front side of the hinged cover for securing the hinged cover to the body.

8. The rooftop shelter according to claim 1, wherein the front side of the hinged cover further comprises a handle.

9. The rooftop shelter according to claim 7, wherein each of the front wall panel, the right wall panel, the left wall panel, and the roof panel has moldings on three sides, the three sides are other than a side pivotally coupled, wherein the moldings permit interlocking of the front wall panel with the left wall panel and the right wall panel, and interlocking of the roof panel with the left wall panel, the right wall panel, and the front wall panel.

10. The rooftop shelter according to claim 1, wherein the rooftop shelter further comprises:
one or more hydraulic gas springs that extend between the hinged cover and the body.

11. A method for providing a rooftop shelter on a roof of a vehicle, the method comprises:
providing a rooftop shelter comprising:
a body, the body has a left side, a front side, a right side, and a rear side,
a hinged cover that has a front side and a rear side, the rear side of the hinged cover is pivotally coupled to the rear side of the body, the hinged cover forms a back wall panel,
a left wall panel pivotally coupled to the left side of the body, the left wall panel configured to pivot between a horizontal state and a vertical state,
a right wall panel pivotally coupled to the right side of the body, the right wall panel configured to pivot between a horizontal state and a vertical state,
a front wall panel pivotally coupled to the front side of the body, the front wall panel configured to pivot between a horizontal state and a vertical state, and
a roof panel, the roof panel is pivotally coupled to the front side of the hinged cover,
wherein the body, the back wall panel, the left wall panel, the front wall panel, the right wall panel, and the roof panel together form a collapsible enclosure; and
mounting the rooftop shelter over the roof of the vehicle.

12. The method according to claim 11, wherein the body is configured to be mounted to a roof of a vehicle.

13. The method according to claim 11, wherein the rooftop shelter further comprises:
one or more windows in the left wall panel and/or right wall panel.

14. The method according to claim 11, wherein the rooftop shelter further comprises a door in the front wall panel.

15. The method according to claim 14, wherein the door has a window.

16. The method according to claim 13, wherein the one or more windows are shielded by one or more mesh screens.

17. The method according to claim 11, wherein the rooftop shelter further comprises:
one or more locks disposed on the front side of the body and the front side of the hinged cover for securing the hinged cover to the body.

18. The method according to claim 11, wherein the front side of the hinged cover further comprises a handle.

19. The method according to claim 17, wherein each of the front wall panel, the right wall panel, the left wall panel, and the roof panel has moldings on three sides, the three sides are other than a side pivotally coupled, wherein the moldings permit interlocking of the front wall panel with the left wall panel and the right wall panel, and interlocking of the roof panel with the left wall panel, the right wall panel, and the front wall panel.

20. The method according to claim 11, wherein the rooftop shelter further comprises:
one or more hydraulic gas springs that extend between the hinged cover and the body.
